(19) United States
(12) Patent Application Publication
(10) Pub. No.: US 2016/0233585 A1
(43) Pub. Date: Aug. 11, 2016

(54) NEAR FIELD COMMUNICATIONS ANTENNA AND TERMINAL INCLUDING THE SAME

(71) Applicant: Samsung Electro-Mechanics Co., Ltd., Suwon-si (KR)

(72) Inventor: Young Min CHEON, Suwon-si (KR)

(73) Assignee: Samsung Electro-Mechanics Co., Ltd., Suwon-si (KR)

(21) Appl. No.: 14/959,439

(22) Filed: Dec. 4, 2015

(30) Foreign Application Priority Data
Feb. 10, 2015 (KR) 10-2015-0020097

(51) Int. Cl. H01Q 7/06; H01Q 7/00; H01Q 1/38; H04W 4/00

(52) U.S. Cl. CPC H01Q 7/06; H04W 4/008; H01Q 7/00; H01Q 1/38

(57) ABSTRACT

A near field communications (NFC) antenna includes: a first sheet including a magnetic material, the magnetic material including a thickness greater than 0 mm and less than or equal to about 0.05 mm; an antenna pattern disposed above the first sheet; and a second sheet disposed between the antenna pattern and the first sheet, wherein an interval between the antenna pattern and the magnetic material is at least about 0.03 mm.

### CROSS-REFERENCE TO RELATED APPLICATION(S)

This application claims the benefit of Korean Patent Application No. 10-2015-0020097 filed on Feb. 10, 2015 in the Korean Intellectual Property Office, the entire disclosure of which is incorporated herein by reference for all purposes.

### BACKGROUND

1. Field

The following description relates to a near field communications (NFC) antenna and a terminal including the same.

2. Description of Related Art

Generally, near field communications (NFC) antennas may perform near field communications in a short range in a non-contact scheme to transmit data between terminals.

Recently, in order to decrease costs of NFC antennas, the size of NFC antennas has been continuously decreased in a range in which electrical specifications remain satisfied.

However, in accordance with the miniaturization of NFC antennas, an interior space accommodating the NFC antenna is decreased, and thus it may be difficult to satisfy desired levels of electrical performance. This problem may result in an increase in costs of NFC antennas, whereby the NFC antenna and a terminal including the same may not be price competitive.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to one general aspect, an NFC antenna includes: a first sheet including a magnetic material, the magnetic material including a thickness greater than 0 mm and less than or equal to about 0.05 mm; an antenna pattern disposed above the first sheet; and a second sheet disposed between the antenna pattern and the first sheet, wherein an interval between the antenna pattern and the magnetic material is at least about 0.03 mm.

The first sheet may further include an adhesive layer adhering the magnetic material to a terminal configured to perform NFC, and the magnetic material may include a ferrite.

The NFC antenna may further include an adhesive layer attached to one surface of the antenna pattern and a protective layer attached to another surface of the antenna pattern, wherein the antenna pattern includes a winding formed on a single-sided flexible printed circuit board (FPCB).

The second sheet may include an adhesive layer, a protective layer, and a film.

The protective layer may include an ink coating or a film.

The second sheet may include a protective layer disposed on an upper surface of the magnetic material.

The second sheet may further include an adhesive layer disposed on the protective layer and attached onto a lower surface of the film.

According to another general aspect, an NFC antenna includes: a first sheet including a magnetic material, the magnetic material comprising a thickness greater than 0 mm and less than or equal to about 0.05 mm; a first antenna pattern disposed above the first sheet; a second antenna pattern disposed above the first antenna pattern; and a second sheet disposed between the first antenna pattern and the first sheet, wherein an interval between the first antenna pattern and the magnetic material is at least about 0.02 mm.

The first sheet may further include an adhesive layer adhering the magnetic material to a terminal configured to perform NFC, and the magnetic material may include a ferrite.

The NFC antenna may further include an adhesive layer attached to one surface of the second antenna pattern and a protective layer attached to another surface of the second antenna pattern, wherein the first antenna pattern and the second antenna pattern include windings formed on a double-sided flexible printed circuit board (FPCB).

The NFC antenna may further include a film disposed between the first antenna pattern and the second antenna pattern, and adhesive layers attached to opposing surfaces of the film, wherein an interval between the first antenna pattern and the second antenna pattern is about 0.01 mm to about 0.2 mm.

The second sheet may include a protective layer disposed on an upper surface of the magnetic material, and an adhesive layer disposed on the protective layer and attached onto a lower surface of the first antenna pattern.

The protective layer may include an ink coating or a film.

Other features and aspects will be apparent from the following detailed description, the drawings, and the claims.

### BRIEF DESCRIPTION OF THE DRAWINGS

FIG. 1 shows a near field communications (NFC) antenna and a terminal including the same, according to an example.

FIG. 2 shows an NFC antenna and a terminal including the same, according to another example.

FIG. 3 is a view illustrating the antenna patterns illustrated in FIGS. 1 and 2.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

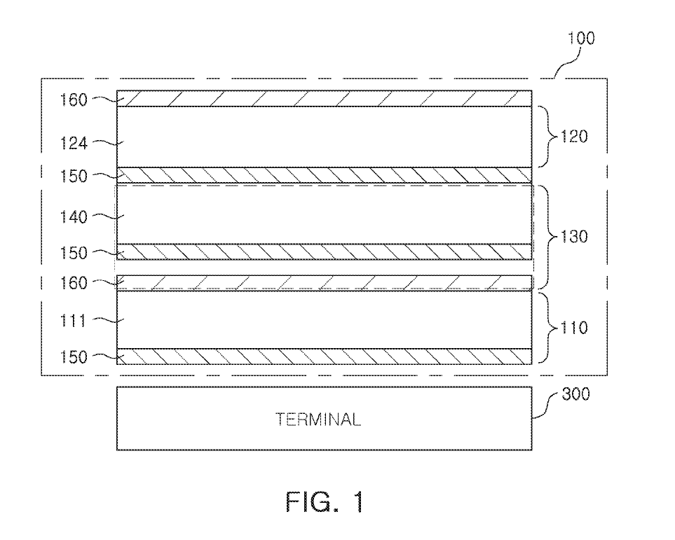

FIG. 1 shows a near field communications (NFC) antenna 100 and a terminal 300 including the NFC antenna 100, according to an example.

Referring to FIG. 1, the NFC antenna 100 includes a first sheet 110, an antenna pattern 120, and a second sheet 130.

The first sheet 110 includes a magnetic material 111 of which a thickness exceeds 0 mm and is about 0.05 mm or less. More specifically, the thickness of the magnetic material may be greater than 0 mm and less than or equal to 0.05 mm. The magnetic material 111 includes a material having high permeability.

A unit cost of the magnetic material 111 per unit volume may be higher than those of other components of the NFC antenna 100. Therefore, as the thickness of the magnetic material 111 is reduced, a unit cost of the NFC antenna 100 may be significantly decreased.

In a case in which the thickness of the magnetic material 111 is reduced to be less than about 0.05 mm, the unit cost of the magnetic material 111 per unit volume may not be relatively higher than those of the components of the NFC antenna 100. In addition, as the thickness of the magnetic material 111 is reduced, a unit cost of the NFC antenna 100 required for satisfying a desired level of electrical performance may be increased. Therefore, in consideration of the unit cost of the material of the NFC antenna 100 and the unit cost of the NFC antenna 100 required for satisfying a desired level of electrical performance, the thickness of the magnetic material 111 may exceed 0 mm and may be about 0.05 mm or less.

For example, the magnetic material 111 included in the first sheet 110 includes a ferrite. The ferrite, a material having high permeability, amplifies a magnetic field of a signal used for NFC. However, the magnetic material 111 is not limited to the ferrite, and may be any material having permeability higher than that of air.

The first sheet 110 further includes an adhesive layer 150 on a lower surface of the magnetic material adhering the magnetic material 111 to a terminal 300 performing the NFC. Therefore, the adhesive layer 150 may include an adhesive tape, or the like, to thereby be attached to the terminal 300.

Since the magnetic material 111 and the terminal 300 are closely adhered to each other by the adhesive layer 150, even though the thickness of the magnetic material 111 is reduced, the magnetic field of the signal used for NFC is efficiently amplified. For example, as the thickness of the magnetic material 111 is reduced, the thickness of the adhesive layer 150 is reduced. Accordingly, a distance between the magnetic material and the terminal 300 is reduced as the thickness of the adhesive layer 150 is reduced.

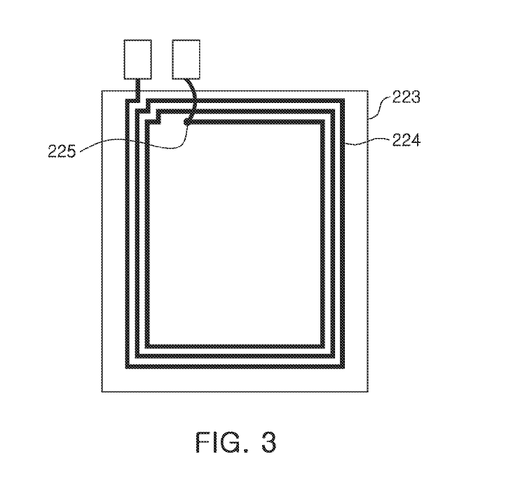

The antenna pattern 120 is formed above the first sheet 110. That is, the antenna pattern 120 is positioned above the first sheet 110 as illustrated in FIG. 1. For example, the antenna pattern 120 includes a winding formed on a single-sided flexible printed circuit board (FPCB). A detailed description of the winding will be described below with reference to FIG. 3.

For example, an adhesive layer 150 is attached onto one surface of the antenna pattern 120, and a protective layer 160 is attached onto the other surface of the antenna pattern 120. Here, the “one surface” of the antenna pattern 120 refers to a lower surface of the antenna pattern 120 facing the first and second sheets 110 and 130, and “the other surface” of the antenna pattern 120 refers to an upper surface of the antenna pattern 120 opposing the one (lower) surface of the antenna pattern 120.

For example, the adhesive layer 150 on the lower surface of the antenna pattern 120 is attached onto an upper surface of the second sheet 130, and the protective layer 160 on the antenna pattern 120 is formed in the outermost portion of the NFC antenna 100. The thickness of the adhesive layer 150 on the antenna pattern 120 may be adjusted to adjust a distance between the antenna pattern 120 and the first sheet 110.

The protective layer 160 may also include an ink coating or film. The protective layer 160 is attached onto the upper surface of the antenna pattern 120, and thus oxidation of and damage to the antenna pattern 120 may be prevented.

The second sheet 130 is formed between the antenna pattern 120 and the first sheet 110 so that an interval (e.g., vertical distance) between the magnetic material 111 included in the first sheet 110 and the antenna pattern 120 is at least about 0.03 mm. More specifically, the interval between the magnetic material 111 and the antenna pattern 120 may be 0.03 mm or more. For example, the second sheet 130 includes a film 140, an adhesive layer 150 attached onto a lower surface of the film 140, and a protective layer 160 attached onto a lower surface of the adhesive layer 150 on the lower surface of the film 140. Here, the film 140 protects the antenna pattern 120, and the adhesive layer 150 on the lower surface of the antenna pattern 120 is disposed on an upper surface of the film 140. By adjusting thicknesses of the components included in the second sheet 130, the interval between the antenna pattern 120 and the magnetic material 111 may be adjusted.

In a case in which the interval between the antenna pattern 120 and the magnetic material 111 is less than about 0.03 mm, it may be difficult to satisfy a desired level of electrical performance of the NFC antenna 100. That is, as the thickness of the magnetic material 111 is reduced, it is significantly difficult to satisfy the desired level of electrical performance of the NFC antenna 100, and in this case, if the interval between the antenna pattern 120 and the magnetic material 111 is also small, the unit cost of the NFC antenna 100 required for satisfying a desired level of electrical performance may be significantly increased.

Therefore, the interval between the antenna pattern 120 and the magnetic material may be about 0.03 mm or more. Here, a space obtained due to a decrease in the thickness of the magnetic material may be partially used to secure the interval between the antenna pattern 120 and the magnetic material.

Even when the interval between the antenna pattern 120 and the magnetic material is increased, so that an entire volume of the NFC antenna 100 is increased, the unit cost of the NFC antenna 100 may not be significantly increased. That is, since a unit cost of the second sheet 130 formed between the antenna pattern 120 and the magnetic material 111 may be relatively lower than that of the magnetic material 111, the unit cost of the NFC antenna 110 may not be significantly increased. As the interval between the antenna pattern 120 and the magnetic material 111 is increased, it may be less difficult to satisfy the desired level of electrical performance of the NFC antenna 100. Therefore, the thickness of the magnetic material 111, of which the unit cost is high, may easily be reduced. As a result, the unit cost of the NFC antenna 100 may be decreased.

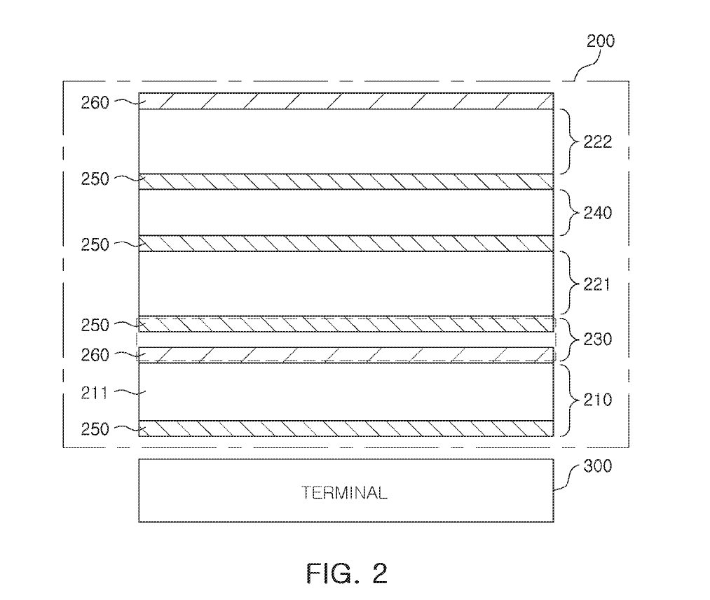

FIG. 2 is an NFC antenna 200 and the terminal 300 including the NFC antenna 300, according to another example.

Referring to FIG. 2, the NFC antenna 200 includes a first sheet 210, a first antenna pattern 221, a second antenna pattern 222, and a second sheet 230. The first sheet 210 is similar to the first sheet 110 included in the NFC antenna 100.

The NFC antenna 200 includes the first antenna pattern 221 and the second antenna pattern 222, unlike the NFC antenna 100 which includes only one antenna pattern 120. The first antenna pattern 221 is formed above the first sheet 210. The second antenna pattern 222 is formed above the first antenna pattern 221. That is, the first antenna pattern 221 is positioned above the first sheet 210 and below the second antenna pattern 222, as illustrated in FIG. 2.

For example, the first antenna pattern 221 and the second antenna pattern 222 include windings formed on a double-sided FPCB. A detailed description of the windings will be described below with reference to FIG. 3.

For example, an adhesive layer 250 is attached onto one (lower) surface of the second antenna pattern 222, and a protective layer 260 is attached onto the other (upper) surface of the second antenna pattern 222. The adhesive layer 250 and the protective layer 260 are similar to the adhesive layer 150 and the protective layer 160 on the antenna pattern 120 included in the NFC antenna 100.

A film 240 having adhesive layers is formed between the first antenna pattern 221 and the second antenna pattern 222. The adhesive layer 250 attached onto the lower surface of the second antenna pattern is also attached onto an upper surface of the film 240, and another adhesive layer 250 is attached onto a lower surface of the film 240. The film 240 protects the first antenna pattern 221 and the second antenna pattern 222.

The second sheet 230 is formed between the first antenna pattern 221 and the first sheet 210, and an interval between the magnetic material 211 included in the first sheet 210 and the first antenna pattern 221 is at least about 0.02 mm. More specifically, the interval between the magnetic material 211 and the first antenna pattern 221 may be 0.02 mm or more.

For example, the second sheet 230 includes an adhesive layer 250 and a protective layer 260 disposed below the adhesive layer 250 of the second sheet 230. By adjusting thicknesses of the components included in the second sheet 230, the interval between the first antenna pattern 221 and the magnetic material 211 may be adjusted.

The interval between the first antenna pattern 221 and the magnetic material 211 is, for example, less than the interval between the first antenna pattern 120 and the magnetic material 111 in the NFC antenna 100. That is, a volume of the NFC antenna 200 including both of the first antenna pattern 221 and the second antenna pattern 222 is larger than that of the NFC antenna 100 including the antenna pattern 120. In addition, since the interval between the second antenna pattern 222 and the magnetic material 211 is larger than the interval between the first antenna pattern 221 and the magnetic material 211, an average interval between the magnetic material 211 and the antenna patterns 221, 222 is larger than the interval between the first antenna pattern 221 and the magnetic material 211.

Therefore, the interval between the first antenna pattern 221 and the magnetic material 211 may be about 0.02 mm or more. An interval between the first antenna pattern 221 and the second antenna pattern 222 may be about 0.01 mm to about 0.2 mm so that the average interval between the magnetic material 211 and the antenna patterns 221, 222 is about 0.03 mm or more. More specifically, the interval between the first antenna pattern 221 and the second antenna pattern 222 may be 0.01 mm to 0.2 mm so that the average interval between the magnetic material 211 and the antenna patterns 221, 222 is 0.03 mm or more. Therefore, a desired level of electrical performance of the NFC antenna 200 may be satisfied and a unit cost of the NFC antenna 200 may be decreased in a similar manner as compared to the NFC antenna 100.

FIG. 3 is a view illustrating the antenna pattern 120/221/222 illustrated in FIGS. 1 and 2.

Referring to FIG. 3, the antenna pattern 120/221/222 includes a flexible printed circuit board 223, a winding 224, and a via 225.

The flexible printed circuit board 223 is, for example, a single-sided flexible printed circuit board included in the antenna pattern 120 or a double-sided flexible printed circuit board included in the first antenna pattern 221 and the second antenna pattern 222.

The winding 224 is wound in a loop form along edges of the flexible printed circuit board 223. A magnetic field may pass through the center of the winding 224. The winding 224 may be connected to an external terminal of the NFC antenna 200.

In the case of the first antenna pattern 221 and the second antenna pattern 222 shown in FIG. 2, the via 225 electrically connects one surface and another, opposite surface of the double-sided flexible printed circuit board to each other.

The antenna pattern 120, first antenna pattern 221 and the second antenna pattern 222 described with reference to FIG. 3 are only examples. That is, the antenna patterns 120, 221, 222 are not limited to the loop form, and may be provided in any form as long as a magnetic field passing through the flexible printed circuit board and the winding may be adjusted.

As set forth above, according to the example embodiments disclosed herein, a desired level of electrical performance of an NFC antenna may be satisfied, and a unit cost of the NFC antenna may be decreased.

As a non-exhaustive example only, a terminal as described herein may be a mobile device, such as a cellular phone, a smart phone, a wearable smart device (such as a ring, a watch, a pair of glasses, a bracelet, an ankle bracelet, a belt, a necklace, an earring, a headband, a helmet, or a device embedded in clothing), a portable personal computer (PC) (such as a laptop, a notebook, a subnotebook, a netbook, or an ultra-mobile PC (UMPC), a tablet PC (tablet), a phablet, a personal digital assistant (PDA), a digital camera, a portable game console, an MP3 player, a portable/personal multimedia player (PMP), a handheld e-book, a global positioning system (GPS) navigation device, or a sensor, or a stationary device, such as a desktop PC, a high-definition television (HDTV), a DVD player, a Blu-ray player, a set-top box, or a home appliance, or any other mobile or stationary device capable of wireless or network communication. In one example, a wearable device is a device that is designed to be mountable directly on the body of the user, such as a pair of glasses or a bracelet. In another example, a wearable device is any device that is mounted on the body of the user using an attaching device, such as a smart phone or a tablet attached to the arm of a user using an armband, or hung around the neck of the user using a lanyard.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A near field communications (NFC) antenna comprising:
a first sheet comprising a magnetic material, the magnetic material comprising a thickness greater than 0 mm and less than or equal to about 0.05 mm;
an antenna pattern disposed above the first sheet; and
a second sheet disposed between the antenna pattern and the first sheet, wherein an interval between the antenna pattern and the magnetic material is at least about 0.03 mm.

2. The NFC antenna of claim 1, wherein:
the first sheet further comprises an adhesive layer adhering the magnetic material to a terminal configured to perform NFC; and
the magnetic material comprises a ferrite.

3. The NFC antenna of claim 1, further comprising an adhesive layer attached to one surface of the antenna pattern and a protective layer attached to another surface of the antenna pattern, wherein the antenna pattern comprises a winding formed on a single-sided flexible printed circuit board (FPCB).

4. The NFC antenna of claim 1, wherein the second sheet comprises an adhesive layer, a protective layer, and a film.

5. The NFC antenna of claim 4, wherein the protective layer comprises an ink coating or a film.

6. The NFC antenna of claim 1, wherein the second sheet comprises a protective layer disposed on an upper surface of the magnetic material.

7. The NFC antenna of claim 6, wherein the second sheet further comprises an adhesive layer disposed on the protective layer and attached onto a lower surface of the film.

8. An NFC antenna comprising:
a first sheet comprising a magnetic material, the magnetic material comprising a thickness greater than 0 mm and less than or equal to about 0.05 mm;
a first antenna pattern disposed above the first sheet;
a second antenna pattern disposed above the first antenna pattern; and
a second sheet disposed between the first antenna pattern and the first sheet, wherein an interval between the first antenna pattern and the magnetic material is at least about 0.02 mm.

9. The NFC antenna of claim 8, wherein:
the first sheet further comprises an adhesive layer adhering the magnetic material to a terminal configured to perform NFC; and
the magnetic material comprises a ferrite.

10. The NFC antenna of claim 8, further comprising an adhesive layer attached to one surface of the second antenna pattern and a protective layer attached to another surface of the second antenna pattern, wherein the first antenna pattern and the second antenna pattern comprise windings formed on a double-sided flexible printed circuit board (FPCB).

11. The NFC antenna of claim 8, further comprising a film disposed between the first antenna pattern and the second antenna pattern, and adhesive layers attached to opposing surfaces of the film, wherein an interval between the first antenna pattern and the second antenna pattern is about 0.01 mm to about 0.2 mm.

12. The NFC antenna of claim 8, wherein the second sheet comprises a protective layer disposed on an upper surface of the magnetic material, and an adhesive layer disposed on the protective layer and attached onto a lower surface of the first antenna pattern.

13. The NFC antenna of claim 12, wherein the protective layer comprises an ink coating or a film.
